(19) United States
(12) Patent Application Publication
(10) Pub. No.: US 2024/0030406 A1
(43) Pub. Date: Jan. 25, 2024

(54) MULTI-IONIC RECHARGEABLE BATTERY

(71) Applicant: FORD GLOBAL TECHNOLOGIES, LLC, Dearborn, MI (US)

(72) Inventors: Feng LI, Troy, MI (US); Patrick PIETRASZ, Rochester, NY (US); Chi PAIK, Grosse Ile, MI (US)

(21) Appl. No.: 17/871,597

(22) Filed: Jul. 22, 2022

(51) Int. Cl. H01M 4/36; H01M 4/58; H01M 4/525; H01M 4/505; H01M 4/485; H01M 10/0525; H01M 10/0585; H01M 10/054

(52) U.S. Cl. CPC H01M 4/364; H01M 4/58; H01M 4/525; H01M 4/505; H01M 4/5825; H01M 4/485; H01M 10/0525; H01M 10/0585; H01M 10/054; H01M 2004/028

(57) ABSTRACT

A mixed positive electrode material for a battery includes a primary positive electrode material that includes nickel in an amount from about 30 weight percent to about 99 weight percent of the total weight of the primary positive electrode material. The primary positive electrode material has a structure that allowed intercalation and de-intercalation of lithium ions. The mixed positive electrode material also includes a secondary positive electrode material having a structure that allows intercalation and de-intercalation of sodium ions. Advantageously, the mixed positive electrode material can be used as the cathode active material in a battery.

### TECHNICAL FIELD

In at least one aspect, a mixed positive electrode material for a battery is provided.

### BACKGROUND

Lithium-ion batteries have successful performance offering high energy and power under a carefully designed system. The lithium-ion battery cells have specific usage criteria in which operations outside of their boundaries can effect cell life. A means to extend the discharge and charge voltage cutoff limits can offer increases in life and energy performance. A redox couple or secondary ions interacting reversibly at extreme voltages and temperatures may preserve the original lithium-ion system.

Accordingly, there is a need for energy designs that increase life and energy performance for lithium-ion batteries.

### SUMMARY

In at least one aspect, a mixed positive electrode material for a battery is provided. The mixed positive electrode material includes a primary positive electrode material that includes nickel in an amount from about 30 weight percent to about 99 weight percent of the total weight of the primary positive electrode material. Advantageously, the primary positive electrode material has a structure that allowed intercalation and de-intercalation of lithium ions. The mixed positive electrode material also includes a secondary positive electrode material having a structure that allows intercalation and de-intercalation of sodium ions.

In another aspect, a positive electrode for a rechargeable battery is provided. The positive electrode includes a current collector and an electrochemically active layer disposed over the current collector. The electrochemically active layer includes a mixed positive electrode material has a primary positive electrode material that includes nickel in an amount from about 30 weight percent to about 99 weight percent of the total weight of the primary positive electrode material. The primary positive electrode material has a structure that allowed intercalation and de-intercalation of lithium ions. The positive electrode also includes a secondary positive electrode material having a structure that allows intercalation and deintercalation of sodium ions.

In another aspect, a rechargeable battery that includes at least one lithium-ion battery cell is provided. Each lithium-ion battery cell includes a positive electrode having a current collector and an electrochemically active layer disposed over the current collector, the electrochemically active layer comprising a mixed positive electrode material. The mixed positive electrode material includes a primary positive electrode material that includes nickel in an amount from about 30 weight percent to about 99 weight percent of the total weight of the primary positive electrode material. The primary positive electrode material has a structure that allowed intercalation and de-intercalation of lithium ions. The rechargeable battery also includes a secondary positive electrode material having a structure that allows intercalation and deintercalation of sodium ions. The rechargeable battery also includes a negative electrode including a negative active material and an electrolyte contacting the positive electrode and the negative electrode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A. Schematic cross-section of an electrode having a mixed electrode active material and coated on one side of a current collector.

FIG. 1B. Schematic cross-section of an electrode having a mixed electrode active material and coated on both sides of a current collector.

FIG. 2. Schematic cross-section of a battery cell incorporating the electrode of FIG. 1A.

FIG. 3. Schematic cross-section of a battery incorporating the battery cell of FIG. 2.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O-M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₈ aryl groups, M⁺ is a metal ion, and L⁻ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O-M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₈ aryl groups, M⁺ is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, amounts, temperature, and reaction conditions (e.g., pressure, pH, flow rates, etc.) can be practiced with plus or minus 50 percent of the values indicated rounded to or truncated to two significant figures of the value provided in the examples. In a refinement, amounts, temperature, and reaction conditions (e.g., pressure, pH, flow rates, etc.) can be practiced with plus or minus 30 percent of the values indicated rounded to or truncated to two significant figures of the value provided in the examples. In another refinement, amounts, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The term “Prussian Blue” refers to blue pigment produced by oxidation of ferrous ferrocyanide salts having a chemical formula of Fe³⁺₄[Fe²⁺(CN)₆]₃

The term “Prussian White” refers to the fully reduced and sodiated form of Prussian Blue. An example of a Prussian white has the chemical formula Na_{1.88(5)}Fe[Fe(CN)₆]·0.18H₂O.

Abbreviations:
“LCO” means lithium cobalt oxide.
“NCMA” means nickel cobalt manganese aluminum quaternary material.
“NCA” means nickel cobalt aluminum ternary material.
“LFP” means lithium iron phosphate.
“LMP” means lithium manganese phosphate.
“LVP” means lithium vanadium phosphate.
“LMO” means lithium manganate.

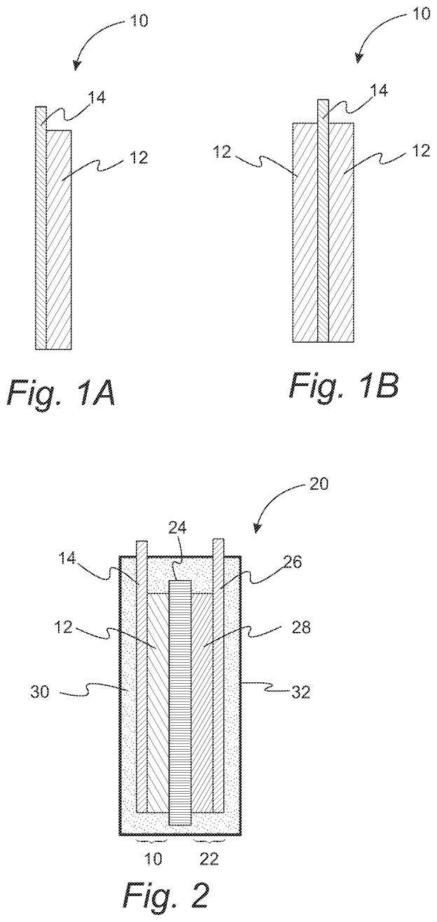

Referring to FIGS. 1A and 1B, schematics of a positive electrode that includes a mixed positive electrode active material are provided. Positive electrode 10 includes a mixed positive electrode active material layer 12 including a mixed positive electrode active material disposed over and typically contacting positive electrode current collector 14. Typically, positive electrode current collector 14 is a metal plate or metal foil composed of a metal such as aluminum, copper, platinum, zinc, titanium, and the like. Currently, copper is most commonly used for the positive electrode current collector. The mixed positive electrode material includes a primary positive electrode material that includes nickel in an amount from about 30 weight percent to about 99 weight percent of the total weight of the primary positive electrode material. Advantageously, the primary positive electrode material has a structure that allowed intercalation and de-intercalation of lithium ions. The mixed positive electrode material also includes a secondary positive electrode material having a structure that allows intercalation and de-intercalation of sodium ions. FIG. 1A shows an example with the mixed positive electrode active material layer 12 disposed over a single face of the current collector 14 while FIG. 1B shows an example with the mixed positive electrode active material layer 12 disposed over two oppose faces of the current collector 14.

In a variation, the primary positive electrode material includes nickel in an amount from about 35 weight percent to about 75 weight percent of the total weight of the primary positive electrode material. In some refinements, the primary positive electrode material includes nickel in an amount of at least 30 weight percent, 35 weight percent, 40 weight percent, 45 weight percent, 50 weight percent, or 55 weight percent of the total weight of the primary positive electrode material and at most in increasing order of preference 99 weight percent, 95 weight percent, 90 weight percent, 85 weight percent, 80 weight percent, or 70 weight percent of the total weight of the primary positive electrode material.

The primary positive electrode material can be any material know in the art that is used as a primary electrode material for lithium-ion batteries. Suitable primary positive electrode materials include but are not limited to nickel cobalt manganese ternary material (NCM), nickel cobalt aluminum ternary material (NCA), nickel cobalt manganese aluminum quaternary material (NCMA), or combinations thereof.

Similarly, the secondary positive electrode material can be any material known to intercalate and de-intercalate sodium ions. Suitable secondary positive electrode materials include but are not limited to Prussian White, Prussian Blue (rhombohedral Na₂MnFe(CN)₆), sodium cobalt oxide (e.g., Na_{0.7}CoO₂₊ₓ), sodium manganese oxide (e.g., Na_{0.44}MnO₂), sodium manganese oxide (e.g., Na_{0.7}MnO₂₊ₓ), sodium iron phosphate (e.g., NaFePO₄), sodium manganese phosphate (NaMnPO₄), sodium chromium oxide (e.g., NaCrO₂), sodium cobalt phosphate (e.g., NaCoPO₄), sodium nickel phosphate (e.g., NaNiPO₄), and combinations thereof. Prussian White is particularly useful as the secondary positive electrode material.

In a variation, the weight ratio of the primary positive electrode material to the secondary positive electrode material is from 1:1 to 99:1. In a refinement, the weight ratio of the secondary positive electrode material to the primary positive electrode material is from 5:1 to 99:1. In some refinements, the weight ratio of the primary positive electrode material to the secondary positive electrode material is at least in increasing order of preference 1:1, 2:1, 5:1, 10:1, 15:1, 20:1, or 30:1, and at most in increasing order of preference 99:1, 90:1, 85:1, 80:1, 70:1, or 60:1.

With reference to FIG. 2, a schematic of a rechargeable battery cell incorporating the positive electrode of FIG. 1 is provided. Battery cell 20 includes positive electrode 10 as described above, negative electrode 22, and separator 24 interposed between the positive electrode and the negative electrode. Negative electrode 22 includes a negative electrode current collector 26 and a negative active material layer 28 disposed over and typically contacting the negative current collector. Typically, negative electrode current collector 26 is a metal plate or metal foil composed of a metal such as aluminum, copper, platinum, zinc, titanium, and the like. Currently, copper is most commonly used for the negative electrode current collector. The battery cell is immersed in electrolyte 30 which is enclosed by battery cell case 32. Electrolyte 30 imbibes into separator 24. In other words, the separator 24 includes the electrolyte thereby allowing lithium ions and sodium ions to move between the negative and positive electrodes. The electrolyte includes a non-aqueous organic solvent, lithium salt, and sodium salt. The non-aqueous organic solvent serves as a medium for transmitting ions taking part in the electrochemical reaction of a battery.

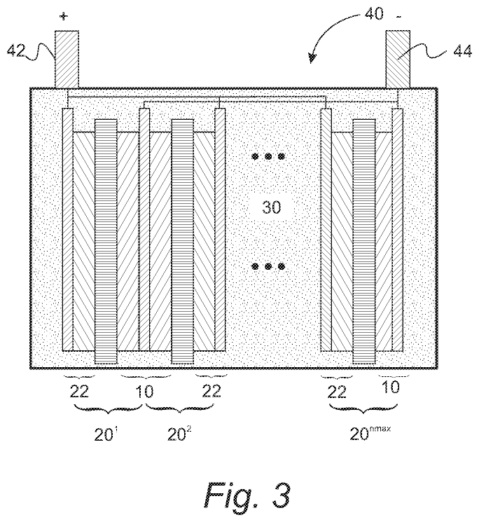

With reference to FIG. 3, a schematic of a rechargeable battery incorporating the positive electrode of FIG. 1 and the battery cells of FIG. 2 is provided. Rechargeable battery 40 includes at least one battery cell of the design in FIG. 2. Typically, rechargeable battery 40 includes at least one battery cell 20ⁱ of the design of FIG. 2. Each battery cell 20ⁱ includes a positive electrode 10 as described above, a negative electrode 22 which includes a negative active material, and an electrolyte 30, where i is an integer label for each battery cell. The label i runs from 1 to nmax, where nmax is the total number of battery cells in rechargeable lithium-ion battery 40. The electrolyte 30 includes a non-aqueous organic solvent, a lithium salt, and a sodium salt. The non-aqueous organic solvent serves as a medium for transmitting ions taking part in the electrochemical reaction of a battery. The plurality of battery cells can be wired in series, in parallel, or a combination thereof. The voltage output from battery 40 is provided across terminals 42 and 44.

Referring to FIGS. 2 and 3, separator 24 physically separates the negative electrode 22 from the positive electrode 10 thereby preventing shorting while allowing the transport of lithium ions and sodium ions for charging and discharging. Therefore, separator 24 can be composed of any material suitable for this purpose. Examples of suitable materials from which separator 24 can be composed include but are not limited to, polytetrafluoroethylene (e.g., TEFLON©), glass fiber, polyester, polyethylene, polypropylene, and combinations thereof. Separator 24 can be in the form of either a woven or non-woven fabric. Separator 24 can be in the form of a non-woven fabric or a woven fabric. For example, a polyolefin-based polymer separator such as polyethylene and/or polypropylene is typically used for a lithium-ion battery. In order to ensure heat resistance or mechanical strength, a coated separator includes a coating of ceramic or a polymer material may be used.

Referring to FIGS. 2 and 3, electrolyte 30 includes a lithium salt and a sodium salt dissolved in the non-aqueous organic solvent. Therefore, electrolyte 30 includes lithium ions and sodium ions that can intercalate into the positive electrode active material during charging and into the anode active material during discharging. Examples of lithium salts include but are not limited to LiPF₆, LiBF₄, LiSbF₆, LiAsF₆, LiC₄F₉SO₃, LiClO₄, LiAlO₂, LiAlCl₄, LiCl, LiI, LiB(C₂O₄)₂, and combinations thereof. In a refinement, the electrolyte includes the lithium salt in an amount from about 0.1 M to about 2.0 M. Examples of sodium salts include but are not limited to NaBF₄, Na[PF6], and combinations thereof. In a refinement, the electrolyte includes the lithium salt in an amount from about 0.1 M to about 2.0 M.

In one variation, the rechargeable battery is configured to predominately operate as a lithium-ion battery and the battery cell is configured to operate as a lithium-ion battery cell. Therefore, in this scenario a weight ratio of the primary positive electrode material to the secondary positive electrode material can be from 1:1 to 99:1 and a weight ratio of a lithium salt to a sodium salt in the electrolyte can be from about 70:30 to 99:1. In a refinement, the weight ratio of the secondary positive electrode material to the primary positive electrode material is from 5:1 to 99:1. In some refinements, the weight ratio of the primary positive electrode material to the secondary positive electrode material is at least in increasing order of preference 1:1, 2:1, 5:1, 10:1, 15:1, 20:1, or 30:1, and at most in increasing order of preference 99:1, 90:1, 85:1, 80:1, 70:1, or 60:1. Similarly, the weight ratio of the lithium salt to the sodium salt in the electrolyte can be at least in increasing order of preference from about preference 1:1, 2:1, 5:1, 10:1, 15:1, 20:1, or 30:1 and at most in increasing order of preference 99:1, 90:1, 85:1, 80:1, 70:1, or 60:1.

In another variation, the rechargeable battery is configured to operate as a sodium-ion battery and the battery cell is configured to operate as a sodium-ion battery cell. Therefore, in this scenario the weight ratio of the primary positive electrode material to the secondary positive electrode material is from 1:99 to 1:3 and a weight ratio of a lithium salt to a sodium salt in the electrolyte is from about 1:20 to 1:3. In some refinements, the weight ratio of the primary positive electrode material to the secondary positive electrode material is at least in increasing order of preference 1:100, 2:100, 5:100, 10:100, 15:100, 20:100, or 30:100, and at most in increasing order of preference 90:100, 80:100, 70:100, 60:100, 50:100, or 40:100. Similarly, the weight ratio of the lithium salt to the sodium salt in the electrolyte can be at least in increasing order of preference from about preference 1:100, 2:100, 5:100, 10:100, 15:100, 20:100, or 30:100 and at most in increasing order of preference 90:100, 80:100, 70:100, 60:100, 50:100, or 40:100.

Still referring to FIGS. 2 and 3, the electrolyte includes a non-aqueous organic solvent, a lithium salt, and a sodium salt. Advantageously, the non-aqueous organic solvent serves as a medium for transmitting ions, and in particular, lithium ions can participate in the electrochemical reaction of a battery. Suitable non-aqueous organic solvents include carbonate-based solvents, ester-based solvents, ether-based solvents, ketone-based solvents, alcohol-based solvents, aprotic solvents, and combinations thereof. Examples of carbonate-based solvents include but are not limited to dimethyl carbonate, diethyl carbonate, dipropyl carbonate, methylpropyl carbonate, ethylpropyl carbonate, methylethyl carbonate, ethylene carbonate, propylene carbonate, butylene carbonate, and combinations thereof. Examples of ester-based solvents include but are not limited to methyl acetate, ethyl acetate, n-propyl acetate, methylpropionate, ethylpropionate, γ-butyrolactone, decanolide, valerolactone, mevalonolactone, caprolactone, and combinations thereof. Examples of ether-based solvents include but are not limited to dibutyl ether, tetraglyme, diglyme, dimethoxyethane, 2-methyltetrahydrofuran, tetrahydrofuran, and the like, and the ketone-based solvent may include cyclohexanone, and the like. Examples of alcohol-based solvent include but are not limited to methanol, ethyl alcohol, n-propyl alcohol, isopropyl alcohol, and the like. Examples of the aprotic solvent include but are not limited to nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, sulfolanes, and the like. Advantageously, the non-aqueous organic solvent can be used singularly. In other variations, mixtures of the non-aqueous organic solvent can be used. Such mixtures are typically formulated to optimize battery performance. In a refinement, a carbonate-based solvent is prepared by mixing a cyclic carbonate and a linear carbonate. In a variation, electrolyte 30 can further include vinylene carbonate or an ethylene carbonate-based compound to increase battery cycle life.

Referring to FIGS. 1, 2, and 3, the negative electrode and the positive electrode can be fabricated by methods known to those skilled in the art of lithium-ion batteries. Typically, an active material (e.g., the mixed positive electrode or negative electrode active material) is mixed with a conductive material, and a binder in a solvent (e.g., N-methylpyrrolidone) into an active material composition and coating the composition on a current collector. The electrode manufacturing method is well known and thus is not described in detail in the present specification. The solvent includes N-methylpyrrolidone and the like but is not limited thereto.

Referring to FIGS. 1, 2, and 3, the positive electrode active material layer 12 includes the mixed positive electrode active material described above including a binder, and a conductive material. The binder can increase the binding properties of positive electrode active material particles with one another and with the positive electrode current collector 14. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, and the like.

Referring to FIGS. 1, 2, and 3, the negative active material layer 26 includes a negative active material, includes a binder, and optionally a conductive material. The negative active materials used herein can be those negative materials known to one skilled in the art of lithium-ion batteries. Negative active materials include but are not limited to, carbon-based negative active materials, silicon-based negative active materials, and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide can be described by the formula SiO_{z} where z is from 0.09 to 1.1. Mixtures of carbon-based negative active materials, silicon-based negative active materials can also be used for the negative active material.

The negative electrode binder increases the binding properties of negative active material particles with one another and with a current collector. The binder can be a non-aqueous binder, an aqueous binder, or a combination thereof. Examples of non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A mixed positive electrode material for a battery, the mixed positive electrode material comprising:
a primary positive electrode material that includes nickel in an amount from about 30 weight percent to about 99 weight percent of the total weight of the primary positive electrode material, the primary positive electrode material has a structure that allowed intercalation and de-intercalation of lithium ions; and
a secondary positive electrode material having a structure that allows intercalation and deintercalation of sodium ions.

2. The mixed positive electrode material of claim 1, wherein the primary positive electrode material includes nickel in an amount from about 35 weight percent to about 75 weight percent of the total weight of the primary positive electrode material.

3. The mixed positive electrode material of claim 1, wherein the primary positive electrode material includes a component selected from the group consisting of nickel cobalt manganese ternary material (NCM), nickel cobalt aluminum ternary material (NCA), nickel cobalt manganese aluminum quaternary material (NCMA), and combinations thereof.

4. The mixed positive electrode material of claim 1, wherein the secondary positive electrode material includes a component selected from the group consisting of Prussian white, Prussian Blue sodium cobalt oxide, sodium manganese oxide, sodium manganese oxide, sodium iron phosphate, sodium manganese phosphate, sodium chromium oxide, sodium cobalt phosphate, sodium nickel phosphate, and combinations thereof.

5. The mixed positive electrode material of claim 1, wherein a weight ratio of the primary positive electrode material to the secondary positive electrode material is from 1:1 to 99:1.

6. The mixed positive electrode material of claim 1, wherein a weight ratio of the secondary positive electrode material to the primary positive electrode material is from 5:1 to 99:1.

7. A positive electrode for a battery comprising;
a current collector; and
an electrochemically active layer disposed over the current collector, the electrochemically active layer comprising a mixed positive electrode material for a battery, the mixed positive electrode material comprising:
a primary positive electrode material that includes nickel in an amount from about 30 weight percent to about 99 weight percent of the total weight of the primary positive electrode material, the primary positive electrode material has a structure that allowed intercalation and de-intercalation of lithium ions; and
a secondary positive electrode material having a structure that allows intercalation and deintercalation of sodium ions.

8. The positive electrode of claim 7, wherein the primary positive electrode material includes a component selected from the group consisting of nickel cobalt manganese ternary material (NCM), nickel cobalt aluminum ternary material (NCA), nickel cobalt manganese aluminum quaternary material (NCMA), and combinations thereof.

9. The positive electrode of claim 7, where the secondary positive electrode material includes a component selected from the group consisting of Prussian White, Prussian Blue sodium cobalt oxide, sodium manganese oxide, sodium manganese oxide, sodium iron phosphate, sodium manganese phosphate, sodium chromium oxide, sodium cobalt phosphate, sodium nickel phosphate, and combinations thereof.

10. The positive electrode of claim 7, wherein a weight ratio of the primary positive electrode material to the secondary positive electrode material is from 1:1 to 99:1 such that the positive electrode is a positive electrode for a lithium-ion battery.

11. The positive electrode of claim 7, wherein a weight ratio of the secondary positive electrode material to the primary positive electrode material is from 5:1 to 99:1 such that the positive electrode is a positive electrode for a sodium-ion battery.

12. A rechargeable battery comprising at least one lithium-ion battery cell, each lithium-ion battery cell including:
a positive electrode comprising:
a current collector; and
an electrochemically active layer disposed over the current collector, the electrochemically active layer comprising a mixed positive electrode material for a battery, the mixed positive electrode material comprising:
a primary positive electrode material that includes nickel in an amount from about 30 weight percent to about 99 weight percent of the total weight of the primary positive electrode material, the primary positive electrode material has a structure that allowed intercalation and de-intercalation of lithium ions; and
a secondary positive electrode material having a structure that allows intercalation and deintercalation of sodium ions;
a negative electrode including a negative active material; and
an electrolyte contacting the positive electrode and the negative electrode.

13. The rechargeable battery of claim 12, wherein the at least one lithium-ion battery cell is a plurality of battery cells.

14. The rechargeable battery of claim 12, wherein each battery cell further includes a separator interposed between the positive electrode and the negative electrode.

15. The rechargeable battery of claim 12, wherein the primary positive electrode material includes a component selected from the group consisting of nickel cobalt manganese ternary material (NCM), nickel cobalt aluminum ternary material (NCA), nickel cobalt manganese aluminum quaternary material (NCMA), and combinations thereof.

16. The rechargeable battery of claim 12, where the secondary positive electrode material includes a component selected from the group consisting of Prussian Blue sodium cobalt oxide, sodium manganese oxide, sodium manganese oxide, sodium iron phosphate, sodium manganese phosphate, sodium chromium oxide, sodium cobalt phosphate, sodium nickel phosphate, and combinations thereof.

17. The rechargeable battery of claim 12 configured to operate as a lithium-ion battery.

18. The rechargeable battery of claim 17, wherein a weight ratio of the primary positive electrode material to the secondary positive electrode material is from 1:1 to 99:1 and a weight ratio of a lithium salt to a sodium salt in the electrolyte is from about 70:30 to 99:1.

19. The rechargeable battery of claim 12 configured to operate as a sodium-ion battery.

20. The rechargeable battery of claim 19, wherein a weight ratio of the primary positive electrode material to the secondary positive electrode material is from 1:99 to 1:3 and a weight ratio of a lithium salt to a sodium salt in the electrolyte is from about 1:20 to 1:3.
